(19) United States
(12) Patent Application Publication
(10) Pub. No.: US 2025/0383969 A1
(43) Pub. Date: Dec. 18, 2025

(54) A METHOD TO DETECT GAME CORE THREADS

(71) Applicant: QUALCOMM Incorporated, San Diego, CA (US)

(72) Inventors: Yang LV, Shanghai (CN); Zhuo FU, Shanghai (CN); Sheng FANG, Shanghai (CN)

(21) Appl. No.: 18/880,195

(22) PCT Filed: Sep. 8, 2022
(86) PCT No.: PCT/CN2022/117687

§ 371 Date: Dec. 30, 2024

(51) Int. Cl. G06F 11/34; G06F 9/54

(52) U.S. Cl. CPC G06F 11/3419; G06F 9/545

(57) ABSTRACT

Various embodiments include methods and devices for identifying core threads of a program executing by a processor. Some embodiments may include hooking an event by a kernel interface, calculating a total time cost for executing a thread of the program based on hooking the event by the kernel interface, returning the total time cost for executing the thread and a thread identifier of the thread to a core thread identifier program by the kernel, and determining a core thread of the program based on the total time cost for executing the thread and the thread identifier of the thread by the core thread identifier program.

### CROSS-REFERENCE TO RELATED APPLICATIONS

This application for Patent is a 371 of international Patent Application PCT/CN2022/117687, filed Sep. 8, 2022, which is hereby incorporated by referenced in its entirety and for all purposes.

### BACKGROUND

Computing devices are implemented with processor cores configured for different performance levels. Programs running on computing devices can suffer from performance degradation when threads critical to the performance of the program are migrated from one processor core to another processor core that is configured for lower performance levels when the threads' task loads of the thread are low, preempted for other threads that are running concurrently, and preempted for less critical threads.

### SUMMARY

Various disclosed aspects include apparatuses and methods of identifying core threads of a program executing by a processor. Various aspects may include hooking an event by a kernel interface, calculating a total time cost for executing a thread of the program based on hooking the event by the kernel interface, returning the total time cost for executing the thread and a thread identifier of the thread to a core thread identifier program by a kernel of the processor, and determining a core thread of the program based on the total time cost for executing the thread and the thread identifier of the thread by the core thread identifier program. Some aspects may further include calculating a duration of at least one task of the thread based on hooking the event. In some aspects, the event includes a switch in of a running processor execution state and out of the running processor execution state for the processor.

Some aspects may further include calculating an aggregate duration for executing at least one task of the thread based on hooking the event, and determining whether the aggregate duration for executing the at least one task of the thread exceeds an aggregation threshold, in which calculating the total time cost for executing the thread of the program based on hooking the event comprises calculating the total time cost for executing the thread of the program in response to determining that the aggregate duration for executing the at least one task of the thread exceeds the aggregation threshold.

Some aspects may further include calculating a representation of the total time cost for executing the thread.

Some aspects may further include comparing the representation of the total time cost for executing the thread to at least one other representation of a total time cost for executing a thread, in which determining the core thread of the program comprises comparing a result of the comparison of the representation of the total time cost for executing the thread to at least one other representation of a total time cost for executing a thread to at least one range of values in which the result of the comparison indicates that a corresponding thread to the representation of the total time cost for executing the thread is a core thread.

Further aspects include a computing device having a processing device configured to perform operations of any of the methods summarized above. Further aspects include a computing device having means for performing functions of any of the methods summarized above. Further aspects include a non-transitory processor-readable medium having stored thereon processor-executable instructions configured to cause a processor and other components of a computing device to perform operations of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a component block and process flow diagram illustrating an example of a program core thread detection system for implementing various embodiments.

FIG. 3 is a block diagram illustrating an example of a progression of execution states of a processor executing a thread for implementing various embodiments.

FIG. 4 is a process flow diagram illustrating a method for detecting program core threads according to various embodiment.

FIG. 5 is a process flow diagram illustrating a method for detecting program core threads according to some embodiments.

FIG. 6 is a component block diagram illustrating an example mobile computing device suitable for implementing various embodiments.

FIG. 7 is a component block diagram illustrating an example mobile computing device suitable for implementing various embodiments.

FIG. 8 is a component block diagram illustrating an example server suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and computing devices implementing such methods for detecting program core threads. Various embodiments may include a method of hooking events implemented in a kernel executing a program, using the events to calculate total time cost of execution of tasks of threads on processor cores, and reporting the total time costs of execution and thread identifiers of the threads to a user program. Some embodiments may further include receiving the total time costs of execution and thread identifiers of the threads from the kernel and using the total time costs of execution and thread identifiers of the threads to identify core threads of the executing program. In some embodiments, the program being executed may be a game program, which may have threads that are critical to the performance of the of the program.

The term “computing device” may refer to stationary computing devices including personal computers, desktop computers, all-in-one computers, workstations, super computers, mainframe computers, embedded computers (such as in vehicles and other larger systems), computerized vehicles (e.g., partially or fully autonomous terrestrial, aerial, and/or aquatic vehicles, such as passenger vehicles, commercial vehicles, recreational vehicles, military vehicles, drones, etc.), servers, multimedia computers, and game consoles. The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor.

Various embodiments are described in terms of code, e.g., processor-executable instructions, for ease and clarity of explanation, but may be similarly applicable to any data, e.g., code, program data, or other information stored in memory. The terms “code”, “data”, and “information” are used interchangeably herein and are not intended to limit the scope of the claims and descriptions to the types of code, data, or information used as examples in describing various embodiments.

Programs running on processors within computing devices can suffer from performance degradation when threads critical to the performance of the of the programs are migrated from processor cores configured for certain performance levels to processor cores configured for lower performance levels when the threads' task loads are low, preempted for other threads that are running concurrently, and preempted for less critical threads. For example, game programs may suffer from reductions in responsiveness to user inputs or smoothness of image display on a display of the computing device (e.g., increased jank or artifacts).

Various embodiments may be used to solve the foregoing problem by identifying threads critical to the performance of the of the programs so that performance reduction mitigation may be implemented for the threads. It is critical to solving the foregoing problems that the threads critical to the performance of the of the programs are identified. Without the threads critical to the performance of the of the programs, performance reduction mitigation may not be and/or may be ineffectively implemented for the program. Examples of performance reduction mitigation using the threads critical to the performance of the of the programs may include assigning the threads to processor cores configured for certain performance levels and/or assigning priority levels to the threads that may be used to avoid preemption of the threads.

A core thread identifier program may instruct a kernel interface (e.g., Berkeley Packet Filter (BPF), eBPF), to hook events for a program executing in a kernel. The kernel interface may identify one or more running tasks of one or more threads of one or more processor core and calculate one or more total time costs of execution of the one or more threads. The kernel interface may report the one or more total time costs of execution and one or more thread identifiers of the one or more threads to the core thread identifier program.

The core thread identifier program may use the one or more total time costs of execution and one or more thread identifiers of the one or more threads to identify one or more core threads of the executing program. The core thread identifier program may store the one or more total time costs of execution and one or more thread identifiers of the one or more threads in association with each other. The one or more total time costs of execution may be sorted and compared by the core thread identifier program to identify which of the one or more associated threads are one or more core threads of the executing program. A core thread of an executing program may be a thread that is critical to the performance of the of the program. For example, the executing program may be a game program and a core thread maybe critical to the performance of the of the program with respect to responsiveness to user inputs, smoothness of image display on a display of a computing device (e.g., increased jank or artifacts), etc.

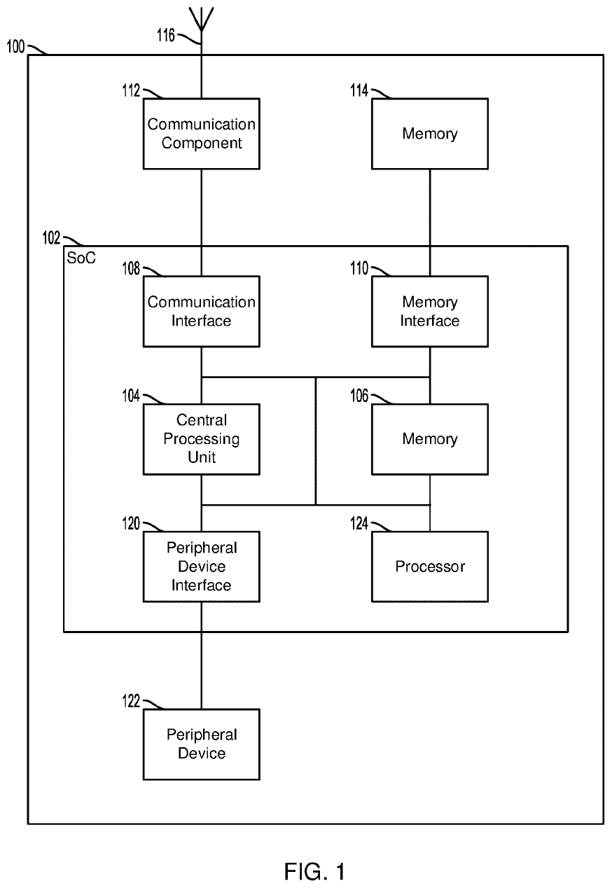

FIG. 1 illustrates a system including a computing device 100 suitable for use with various embodiments. The computing device 100 may include an SoC 102 with a central processing unit 104, a memory 106, a communication interface 108, a memory interface 110, a peripheral device interface 120, and a processing device 124. The computing device 100 may further include a communication component 112, such as a wired or wireless modem, a memory 114, an antenna 116 for establishing a wireless communication link, and/or a peripheral device 122. The processor 124 may include any of a variety of processing devices, for example a number of processor cores.

The term “system-on-chip” or “SoC” is used herein to refer to a set of interconnected electronic circuits typically, but not exclusively, including a processing device, a memory, and a communication interface. A processing device may include a variety of different types of processors 124 and/or processor cores, such as a general purpose processor, a central processing unit (CPU) 104, a digital signal processor (DSP), a graphics processing unit (GPU), an accelerated processing unit (APU), a secure processing unit (SPU), an intellectual property unit (IPU), a subsystem processor of specific components of the computing device, such as an image processor for a camera subsystem or a display processor for a display, an auxiliary processor, a peripheral device processor, a single-core processor, a multicore processor, a controller, and/or a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and/or time references. Integrated circuits may be configured such that the components of the integrated circuit reside on a single piece of semiconductor material, such as silicon.

An SoC 102 may include one or more CPUs 104 and processors 124. The computing device 100 may include more than one SoC 102, thereby increasing the number of CPUs 104, processors 124, and processor cores. The computing device 100 may also include CPUs 104 and processors 124 that are not associated with an SoC 102. Individual CPUs 104 and processors 124 may be multicore processors. The CPUs 104 and processors 124 may each be configured for specific purposes and/or with specific performance parameters that may be the same as or different from other CPUs 104 and processors 124 of the computing device 100. For example, the CPUs 104 and processors 124 may be configured to operate at different frequencies, which may be described in relative terms, such as high/higher frequency/performance and low/lower frequency/performance, with respect to each other. For further example, one or more of the CPUs 104 and/or processors 124 may be high performance CPUs 104 and/or processors 124 relative to one or more other CPUs 104 and/or processors 124. Similarly, one or more of the CPUs 104 and/or processors 124 may be low performance CPUs 104 and/or processors 124 relative to one or more other CPUs 104 and/or processors 124. In some examples, high performance CPUs 104 and/or processors 124 may be referred to as gold CPUs 104, processors 124, and/or cores and low performance CPUs 104 and/or processors 124 may be referred to as silver CPUs 104, processors 124, and/or cores. One or more of the CPUs 104, processors 124, and processor cores of the same or different configurations may be grouped together. A group of CPUs 104, processors 124, or processor cores may be referred to as a multi-processor cluster.

The memory 106 of the SoC 102 may be a volatile or non-volatile memory configured for storing data and processor-executable code for access by the CPU 104, the processor 124, or other components of SoC 102. The computing device 100 and/or SoC 102 may include one or more memories 106 configured for various purposes. One or more memories 106 may include volatile memories such as random-access memory (RAM) or main memory, or cache memory. These memories 106 may be configured to temporarily hold a limited amount of data received from a data sensor or subsystem, data and/or processor-executable code instructions that are requested from non-volatile memory, loaded to the memories 106 from non-volatile memory in anticipation of future access based on a variety of factors, and/or intermediary processing data and/or processor-executable code instructions produced by the CPU 104 and/or processor 124 and temporarily stored for future quick access without being stored in non-volatile memory. In some embodiments, any number and combination of memories 106 may include one-time programmable or read-only memory.

The memory 106 may be configured to store data and processor-executable code, at least temporarily, that is loaded to the memory 106 from another memory device, such as another memory 106 or memory 114, for access by one or more of the CPU 104, the processor 124, or other components of SoC 102. The data or processor-executable code loaded to the memory 106 may be loaded in response to execution of a function by the CPU 104, the processor 124, or other components of SoC 102. Loading the data or processor-executable code to the memory 106 in response to execution of a function may result from a memory access request to another memory 106 or memory 114, and the data or processor-executable code may be loaded to the memory 106 for later access.

The memory interface 110 and the memory 114 may work in unison to allow the computing device 100 to store data and processor-executable code on a volatile and/or non-volatile storage medium, and retrieve data and processor-executable code from the volatile and/or non-volatile storage medium. The memory 114 may be configured much like an embodiment of the memory 106 in which the memory 114 may store the data or processor-executable code for access by one or more of the CPU 104, the processor 124, or other components of SoC 102. In some embodiments, the memory 114, being non-volatile, may retain the information after the power of the computing device 100 has been shut off. When the power is turned back on and the computing device 100 reboots, the information stored on the memory 114 may be available to the computing device 100. In some embodiments, the memory 114, being volatile, may not retain the information after the power of the computing device 100 has been shut off. The memory interface 110 may control access to the memory 114 and allow the CPU 104, the processor 124, or other components of the SoC 12 to read data from and write data to the memory 114.

Some or all of the components of the computing device 100 and/or the SoC 102 may be arranged differently and/or combined while still serving the functions of the various embodiments. The computing device 100 may not be limited to one of each of the components, and multiple instances of each component may be included in various configurations of the computing device 100.

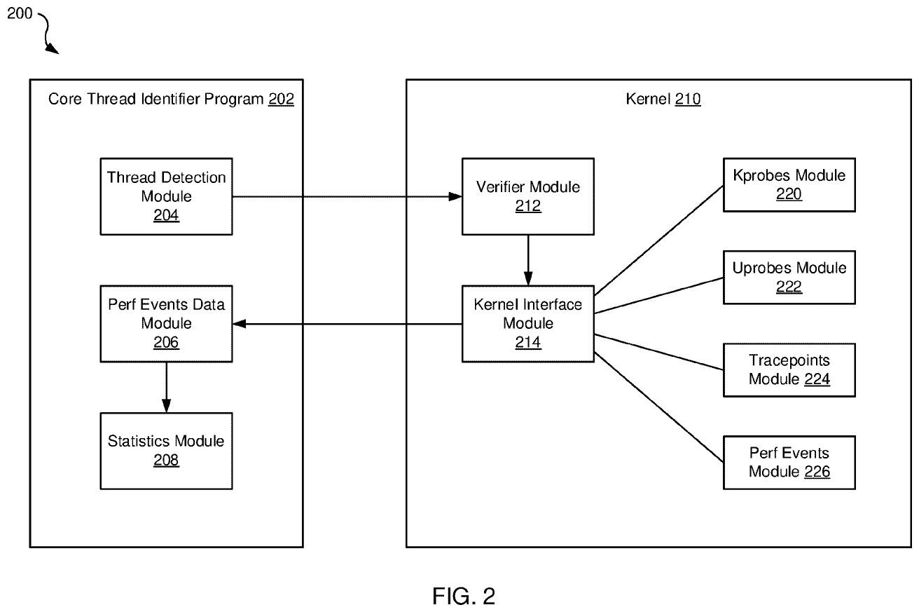

FIG. 2 illustrates an example of a program core thread detection system for implementing various embodiments. With reference to FIGS. 1 and 2, the program core thread detection system 200 may be implemented in any number and combination of processors (e.g., CPU 104, processor 124 in FIG. 1) and may include a core thread identifier program 202 and a kernel/operating system 210 (e.g., a Unix-like kernel, a Windows-like kernel). The core thread identifier program 202 may be configured to instruct the kernel 210 to provide the core thread identifier program 202 with total time costs of execution of threads and thread identifiers of the threads of programs executing on processors and determine which of the threads are core threads. The kernel 210 may be configured to track execution times of the tasks of the threads of the programs executing on the processors, determine the total time costs of execution of the threads, and provide the core thread identifier program 202 with the total time costs of execution and the thread identifiers of the threads.

The core thread identifier program 202 may include a thread detection module 204, a perf events data module 206, and a statistics module 208. The thread detection module 204 may be configured to instruct the kernel 210, such as via a kernel interface module 214 (e.g., Berkeley Packet Filter (BPF), eBPF), to monitor execution of tasks by threads of programs executing on processors for events, to use the events to calculate times for execution of the tasks and total time costs of execution of the threads. The thread detection module 204 may further instruct the kernel interface module 214 to provide the total time costs of execution of the threads and thread identifiers of the threads to the core thread identifier program 202.

The perf events data module 206 may receive the total time costs of execution of the threads and thread identifiers of the threads from the kernel interface module 214. The perf events data module 206 may store the corresponding total time costs of execution of the threads and thread identifiers of the threads in association with each other. For example, the total time costs of execution of the threads and thread identifiers of the threads may be stored in association with each other in a memory (e.g., memory 106 in FIG. 1), such as a cache and/or a main memory. The perf events data module 206 may store the corresponding total time costs of execution of the threads and thread identifiers of the threads in association with each other in any of various free form data formats, data structures, databases, etc.

The statistics module 208 may be configured to analyze the stored total time costs of execution of the threads and thread identifiers of the threads. Such analysis may include identifying one or more of the threads as core threads of the programs executing on the processors. The statistics module 208 may identify threads having greater total time costs of execution of the threads than other threads. The statistics module 208 may generate representations of the total time costs of execution of the threads and compare the representations. For example, the representations of the total time costs of execution of the threads may be weighted based on the total time costs of execution of the threads relative to a value, such as an aggregation threshold time. For a more specific example, the representations of the total time costs of execution of the threads may be the value divided by the total time costs of execution of the threads.

The statistics module 208 may store the corresponding representations of the total time costs of execution of the threads and thread identifiers of the threads in association with each other. For example, the representations of the total time costs of execution of the threads and thread identifiers of the threads may be stored in association with each other in a memory (e.g., memory 106 in FIG. 1), such as a cache and/or a main memory. The statistics module 208 may store the corresponding representations of the total time costs of execution of the threads and thread identifiers of the threads in association with each other in any of various free form data formats, data structures, databases, etc.

The statistics module 208 may compare the representations of the total time costs of execution of the threads to one another to determine the threads having greater total time costs of execution of the threads. For example, a certain number of the representations of the total time costs of execution of the threads having the greatest values with respect to the remaining representations may be compared to each other. In some examples, the representations of the total time costs of execution of the threads may be sorted, such as in ascending and/or descending order, and the certain number of the representations may be from a corresponding end of the sorted representations. To compare the certain number of the representations of the total time costs of execution of the threads, the greatest value representation may be compared with each of the other of the certain number of representations. The results of the comparisons within one or more ranges of core thread values or core thread thresholds may be used to identify the representations of the total time costs of execution of the threads as a representation for core threads. The greatest value representation of the total time costs of execution of a thread may also be identified as a representation for a core thread. The statistics module 208 may identify the thread identifiers associated with the representation for core threads as thread identifiers of core threads.

The kernel 210 may include a verifier module 212, a kernel interface module 214, and one or more of a Kprobes module 220, a Uprobes module 222, and a tracepoints module 224, and a perf events module 226. The verifier module 212 may be configured to verify the code instructions provided to the kernel 210 by the thread detection module 204, by known means, and provide the verified code instructions to the kernel interface module 214.

The kernel interface module 214 may implement the code instructions to monitor execution of the tasks by the threads of the programs executing on the processors for events. For example, the kernel interface module 214 may implement the code instructions to implement to hook events and record data related to the tasks in response to an event hook. The kernel interface module 214 may implement the Kprobes module 220 to hook kernel functions, the Uprobes module 222 to hook user functions, and/or the tracepoints module 224 to hook predetermined tracepoints. For example, the kernel interface module 214 may implement the tracepoints module 224 to hook sched_switch events to monitor for when the processor changes states between running and not running a task.

The kernel interface module 214 may implement the code instructions to record timestamps for the sched_switch events and/or calculate durations between the sched_switch events, such as between running and not running a task to represent a duration of a task execution. The kernel interface module 214 may implement the code instructions to calculate total time costs of execution of the threads and identify thread identifiers of the threads. The kernel interface module 214 may implement the code instructions to return the total time costs of execution of the threads and the thread identifiers of the threads to the core thread identifier program 202. For example, the kernel interface module 214 may implement the perf events module 226 to implement returning the total time costs of execution of the threads and the thread identifiers of the threads to the core thread identifier program 202.

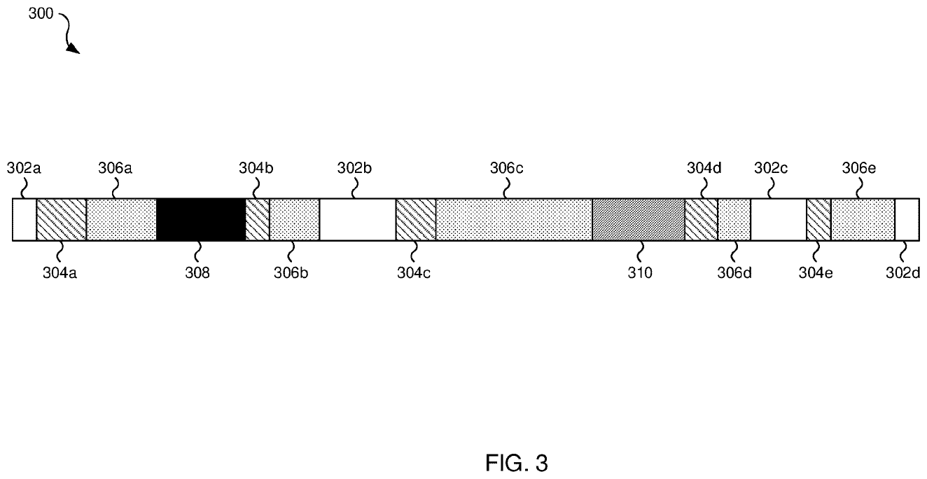

FIG. 3 illustrates an example of a progression of execution states of a processor executing a thread for implementing various embodiments. With reference to FIGS. 1-3, a processor (e.g., CPU 104, processor 124 in FIG. 1) executing a thread 300 of a program may transition through various execution states over a duration of the thread execution. For example, the processor may be in a sleep state 302a, 302b, 302c, 302d, an uninterruptable sleep state 308, and/or an uninterruptable sleep state blocking I/O 310 when no task of the thread is ready for execution. The processor may be in a runnable state 304a, 304b, 304c, 304d, 304e when a task of the thread is ready for execution. The processor may be in a running state 306a, 306b, 306c, 306d, 306e when a task of the thread is being executed by the processor.

Switching the execution state for the processor in and out of running state 306a, 306b, 306c, 306d, 306e may trigger a sched_switch event that may be hooked by a kernel (e.g., kernel 220, kernel interface module, interface module 214, tracepoints module 224 in FIG. 2). The kernel may monitor for the sched_switch events and use the sched_switch event to record data for calculating the duration of each task execution. The kernel may aggregate the duration of each task execution for calculating the total time cost of execution of the thread 300.

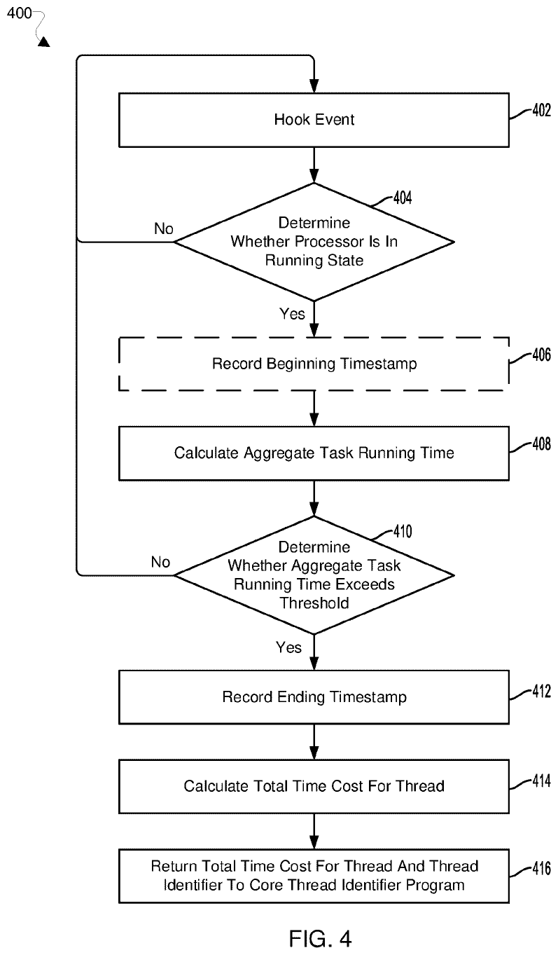

FIG. 4 illustrates a method 400 for detecting program core threads according to various embodiments. With reference to FIGS. 1-4, the method 400 may be implemented in a computing device (e.g., computing device 100), in hardware, in software executing in a processor, or in a combination of a software-configured processor and dedicated hardware (e.g., CPU 104, processor 124 in FIG. 1, kernel 210, verifier module 212, kernel interface module 214, Kprobes module 220, Uprobes module 222, tracepoints module 224, perf events module 226 in FIG. 2) that includes other individual components, such as various memories/caches (e.g., memory 106, 114 in FIG. 1) and various memory/cache controllers. In order to encompass the alternative configurations enabled in various embodiments, the hardware implementing the method 400 is referred to herein as a “processing device.”

In block 402, the processing device may hook an event. In response to instructions received from a core thread identifier program (e.g., core thread identifier program 202, thread detection module 204 in FIG. 2), the processing device may implement the instructions to hook an event during execution of a program. For example, the event may be a sched_switch event to monitor for a state switch for a processor (e.g., CPU 104, processor 124 in FIG. 1) executing the program, such as switching in and out of a running state of the processor when starting to and ending executing a task of the program. In some embodiments, the processing device hooking the event in block 402 may be a processor (e.g., CPU 104, processor 124 in FIG. 1), a kernel (e.g., kernel 210 in FIG. 2), a kernel interface module (e.g., kernel interface module 214 in FIG. 2), a Kprobes module (e.g., Kprobes module 220 in FIG. 2), a Uprobes module 222 (e.g., Uprobes module 222 in FIG. 2), and/or a tracepoints module (e.g., tracepoints module 224 in FIG. 2).

In block 404, the processing device may determine whether the processor executing the program is in the running state. The hook of the event may enable the processing device to monitor the state changes of the processor. The processing device may identify the state of the processor, particularly when the processor is in the running state, executing a task of the program. The processing device may identify the state of the processor by known means and determine whether the processor is in the running state based on the identified state of the processor. In some embodiments, the processing device determining whether the processor executing the program is in the running state in determination block 404 may be the processor, the kernel, and/or the kernel interface module.

In response to determining that the processor executing the program is in the running state (i.e., determination block 404=“Yes”), the processing device may record a beginning timestamp in optional block 406. For a first task execution by a thread of the program during a specified duration, such as a duration corresponding to an aggregation threshold (described further herein), the processing device may record a timestamp at the commencement of the execution of the task. The beginning timestamp may be recorded in a memory (e.g., memory 106 in FIG. 1). In some embodiments, the processing device may implement recording the beginning timestamp in optional block 406 a designated number of times, such as once, per specified duration. Whether the processing device has implemented recording the beginning timestamp in optional block 406 for a specified duration may be indicated by setting a beginning timestamp flag, such as a register or buffer value. In some embodiments, the processing device recording the beginning timestamp in optional block 406 may be the processor, the kernel, and/or the kernel interface module.

In block 408, the processing device may calculate an aggregate task running time. The processing device, based on the hook of the event, may calculate a duration for executing each task by the processor during the specified duration. For example, the processing device may use timestamps for the events and calculate a difference between the timestamps to calculate a duration of an execution of a task. As another example, the processing device may control a timer based on the events and use a duration measured by the timer to calculate a duration of an execution of a task. The processing device may aggregate the duration for executing each task by the processor during the specified duration to calculate the aggregate task running time. In some embodiments, the processing device calculating the aggregate task running time in block 408 may be the processor, the kernel, and/or the kernel interface module.

In determination block 410, the processing device may determine whether the aggregate task running time exceeds an aggregation threshold. The aggregation threshold may be a predetermined value, such as a value of a duration during which to aggregate the duration for executing each task by the processor. For example, the aggregation threshold may be between approximately 100 ms and approximately 1000 ms, such as approximately 500 ms. The processing device may compare the aggregate task running time and the aggregation threshold. From the result of the comparison, the processing device may determine whether the aggregate task running time exceeds the aggregation threshold. In some embodiments, the processing device determining whether the aggregate task running time exceeds the aggregation threshold in determination block 410 may be the processor, the kernel, and/or the kernel interface module.

In response to determining that the aggregate task running time exceeds the aggregation threshold (i.e., determination block 410=“Yes”), the processing device may record an ending timestamp in block 412. For a last task execution by the thread of the program during the specified duration, such as the duration corresponding to the aggregation threshold, the processing device may record a timestamp at the completion of the execution of the task. The ending timestamp may be recorded in a memory (e.g., memory 106 in FIG. 1). In some embodiments, the processing device recording the ending timestamp in block 412 may be the processor, the kernel, and/or the kernel interface module.

In block 414, the processing device may calculate a total time cost of execution for the thread. The processing device may use the recorded beginning timestamp and ending timestamp to determine the total time cost of execution for the thread. For example, the processing device may calculate a difference between the ending timestamp and the beginning timestamp as the total time cost of execution for the thread. In some embodiments, the processing device calculating the total time cost of execution for the thread in block 414 may be the processor, the kernel, and/or the kernel interface module.

In block 416, the processing device may return the total time cost of execution for the thread and a thread identifier for the thread to the thread identifier program. The processing device may retrieve a thread identifier for the thread of the program executed by the processing by known means. The processing device may implement a callback function of the instructions received from the core thread identifier program, such as perf_output, to provide the total time cost of execution for the thread and the thread identifier for the thread to the thread identifier program. In some embodiments, the processing device returning the total time cost of execution for the thread and the thread identifier for the thread to the thread identifier program in block 416 may be the processor, the kernel, the kernel interface module, and/or a perf events module (e.g., perf events module 226 in FIG. 2).

In response to determining that the processor executing the program is not in the running state (i.e., determination block 404=“No”), or in response to determining that the aggregate task running time does not exceed the aggregation threshold (i.e., determination block 410=“Yes”), the processing device may continuously, repeatedly, and/or periodically hook an event in block 402.

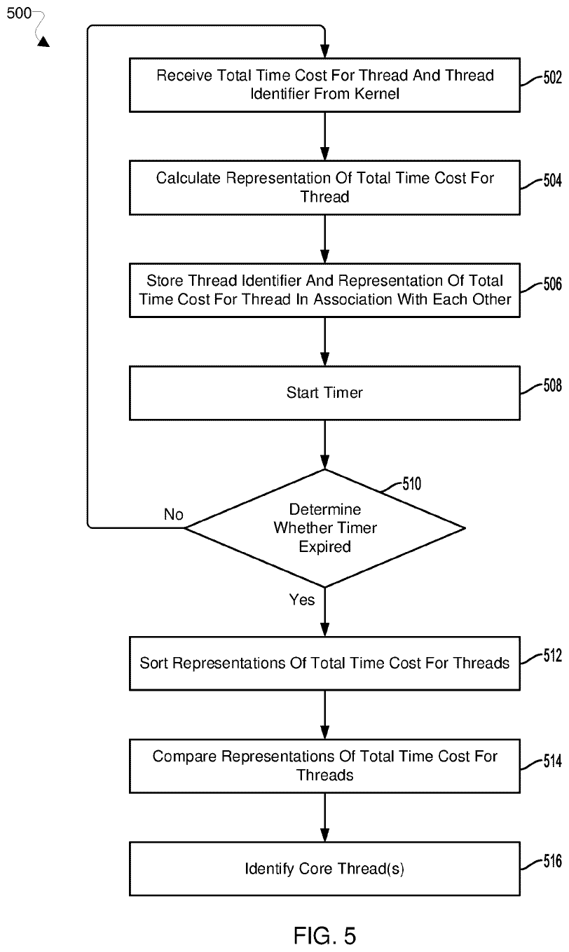

FIG. 5 illustrates a method 500 for detecting program core threads according to an embodiment. With reference to FIGS. 1-5, the method 500 may be implemented in a computing device (e.g., computing device 100), in hardware, in software executing in a processor, or in a combination of a software-configured processor and dedicated hardware (e.g., CPU 104, processor 124 in FIG. 1, core thread identifier program 202, thread detection module 204, perf events data module 206, statistics module 208 in FIG. 2) that includes other individual components, such as various memories/caches (e.g., memory 106, 114 in FIG. 1) and various memory/cache controllers. In order to encompass the alternative configurations enabled in various embodiments, the hardware implementing the method 500 is referred to herein as a “processing device.”

In block 502, the processing device may receive a total time cost of execution for a thread and a thread identifier for the thread from a kernel (e.g., kernel 210, kernel interface module 214, perf events module 226 in FIG. 2). The processing device may receive the receive the total time cost for the thread and the thread identifier for the thread from a kernel returned by the processing device in block 416 of the method 400 as described. In some embodiments, the processing device receiving the total time cost for the thread and the thread identifier for the thread from the kernel in block 502 may be a processor (e.g., CPU 104, processor 124 in FIG. 1), a core thread identifier program (e.g., core thread identifier program 202 in FIG. 2), and/or a perf events data module (e.g., perf events data module 206 in FIG. 2).

In block 504, the processing device may calculate a representation of the total time cost of execution for the thread. The processing device may generate the representation of the total time cost of execution of the thread by algorithmic means. For example, the representation of the total time cost of execution of the thread may be weighted based on the total time cost of execution of the thread relative to a value, such as the aggregation threshold time. For a more specific example, the representations of the total time cost of execution of the thread may be the value divided by the total time cost of execution of the thread. In some embodiments, the processing device calculating the representation of the total time cost of execution for the thread in block 504 may be the processor, the core thread identifier program, and/or a statistics module (e.g., statistics module 208 in FIG. 2).

In block 506, the processing device may store the representation of the total time cost of execution for the thread and the thread identifier for the thread in association with each other. The processing device may store the corresponding representations of the total time costs of execution of the threads and thread identifiers of the threads in association with each other. For example, the representations of the total time costs of execution of the threads and thread identifiers of the threads may be stored in association with each other in a memory (e.g., memory 106 in FIG. 1), such as a cache and/or a main memory. The processing device may store the corresponding representations of the total time costs of execution of the threads and thread identifiers of the threads in association with each other in any of various free form data formats, data structures, databases, etc. In some embodiments, the processing device storing the representation of the total time cost of execution for the thread and the thread identifier for the thread in association with each other in block 506 may be the processor, the core thread identifier program, and/or the statistics module.

In block 508, the processing device may start a timer. The timer may be configured to measure a duration, such as time, and may be used to determine an elapsed duration. The timer may be a timer configured for a specific duration and/or a timer configured without a specific duration. The processing device may track progress of the timer. In some embodiments, the processing device starting the timer in block 508 may be the processor, the core thread identifier program, and/or the statistics module.

In determination block 510, the processing device may determine whether the timer has expired. For example, the timer may expire upon completion of the set duration and may trigger a signal, that may be received by the processing device, that the timer has expired. As another example, the processing device may compare the timer to a timer threshold and determine whether the timer has expired based on the comparison. In some embodiments, the processing device determining whether the timer has expired in determination block 510 may be the processor, the core thread identifier program, and/or the statistics module.

In response to determining that the timer has expired (i.e., determination block 510=“Yes”), the processing device may sort the representations of the total time costs of execution of the threads in block 512. For example, the representations of the total time costs of execution of the threads may be sorted, such as in ascending and/or descending order. In some embodiments, the processing device sorting the representations of the total time costs of execution of the threads in block 512 may be the processor, the core thread identifier program, and/or the statistics module.

In block 514, the processing device may compare the representations of the total time costs of execution of the threads. The processing device may compare the representations of the total time costs of execution of the threads to one another to determine the threads having greater total time costs of execution of the threads. For example, a certain number of the representations of the total time costs of execution of the threads having the greatest values with respect to the remaining representations may be compared to each other. In some examples, the certain number of the representations may be from a portion, such as an end, of the sorted representations corresponding to the greatest values of the representations of the total time costs of execution of the threads. To compare the certain number of the representations of the total time costs of execution of the threads, the greatest value representation may be compared with each of the other of the certain number of representations. For example, the processing device may divide the each of the other of the certain number of representations of the total time costs of execution of the threads by the greatest value representation. In some embodiments, the processing device comparing the representations of the total time costs of execution of the threads in block 514 may be the processor, the core thread identifier program, and/or the statistics module.

In block 516, the processing device may identify one or more core threads of the program executed by the processor. The results of the comparisons may be used to determine whether the threads are core threads. For examples, the results of the comparisons may be compared to one or more patterns of comparison results for combinations of one or more core threads. The results of the comparisons within one or more ranges of core thread values or core thread thresholds may be used to identify the representations of the total time costs of execution of the threads as a representation for core threads. For example, the results of the comparisons within multiple ranges of core thread values or core thread thresholds may identify the corresponding representations of the total time costs of execution of the threads as a representation for core threads. The greatest value representation of the total time costs of execution of a thread may also be identified as a representation for a core thread. The processing device may identify the thread identifiers associated with the representation for core threads as thread identifiers of core threads. In some embodiments, the processing device identify the one or more core threads of the program executed by the processor in block 516 may be the processor, the core thread identifier program, and/or the statistics module.

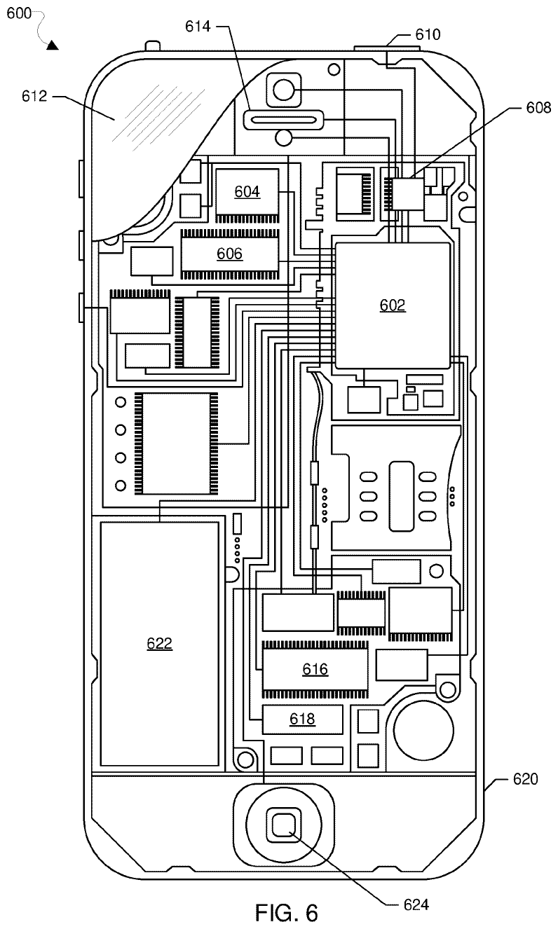

A system in accordance with the various embodiments (including, but not limited to, embodiments described above with reference to FIGS. 1-9) may be implemented in a wide variety of computing systems including mobile computing devices, an example of which suitable for use with the various embodiments is illustrated in FIG. 6. The mobile computing device 600 may include a processor 602 coupled to a touchscreen controller 604 and an internal memory 606. The processor 602 may be one or more multicore integrated circuits designated for general or specific processing tasks. The internal memory 606 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 604 and the processor 602 may also be coupled to a touchscreen panel 612, such as a resistive-sensing touchscreen, capacitive-sensing touchscreen, infrared sensing touchscreen, etc. Additionally, the display of the mobile computing device 600 need not have touch screen capability.

The mobile computing device 600 may have one or more radio signal transceivers 608 (e.g., Peanut, Bluetooth, ZigBee, Wi-Fi, RF radio) and antennae 610, for sending and receiving communications, coupled to each other and/or to the processor 602. The transceivers 608 and antennae 610 may be used with the above-mentioned circuitry to implement the various wireless transmission protocol stacks and interfaces. The mobile computing device 600 may include a cellular network wireless modem chip 616 that enables communication via a cellular network and is coupled to the processor.

The mobile computing device 600 may include a peripheral device connection interface 618 coupled to the processor 602. The peripheral device connection interface 618 may be singularly configured to accept one type of connection, or may be configured to accept various types of physical and communication connections, common or proprietary, such as Universal Serial Bus (USB), FireWire, Thunderbolt, or PCIe. The peripheral device connection interface 618 may also be coupled to a similarly configured peripheral device connection port (not shown).

The mobile computing device 600 may also include speakers 614 for providing audio outputs. The mobile computing device 600 may also include a housing 620, constructed of a plastic, metal, or a combination of materials, for containing all or some of the components described herein. The mobile computing device 600 may include a power source 622 coupled to the processor 602, such as a disposable or rechargeable battery. The rechargeable battery may also be coupled to the peripheral device connection port to receive a charging current from a source external to the mobile computing device 600. The mobile computing device 600 may also include a physical button 624 for receiving user inputs. The mobile computing device 600 may also include a power button 624 for turning the mobile computing device 600 on and off.

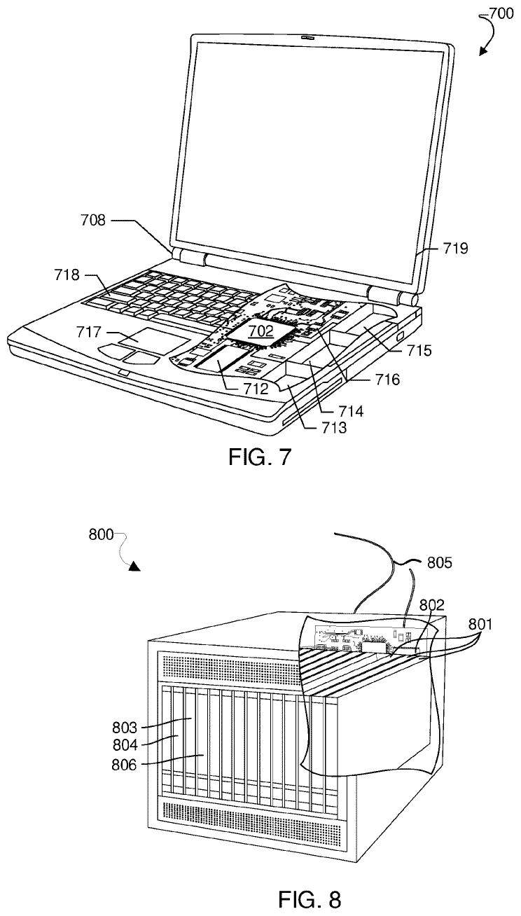

A system in accordance with the various embodiments (including, but not limited to, embodiments described above with reference to FIGS. 1-9) may be implemented in a wide variety of computing systems include a laptop computer 700 an example of which is illustrated in FIG. 7. Many laptop computers include a touchpad touch surface 717 that serves as the computer's pointing device, and thus may receive drag, scroll, and flick gestures similar to those implemented on computing devices equipped with a touch screen display and described above. A laptop computer 700 will typically include a processor 702 coupled to volatile memory 712 and a large capacity nonvolatile memory, such as a disk drive 713 of Flash memory. Additionally, the computer 700 may have one or more antenna 708 for sending and receiving electromagnetic radiation that may be connected to a wireless data link and/or cellular telephone transceiver 716 coupled to the processor 702. The computer 700 may also include a floppy disc drive 714 and a compact disc (CD) drive 715 coupled to the processor 702. In a notebook configuration, the computer housing includes the touchpad 717, the keyboard 718, and the display 719 all coupled to the processor 702. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-5) may also be implemented in fixed computing systems, such as any of a variety of commercially available servers. An example server 800 is illustrated in FIG. 8. Such a server 800 typically includes one or more multicore processor assemblies 801 coupled to volatile memory 802 and a large capacity nonvolatile memory, such as a disk drive 804. As illustrated in FIG. 8, multicore processor assemblies 801 may be added to the server 800 by inserting them into the racks of the assembly. The server 800 may also include a floppy disc drive, compact disc (CD) or digital versatile disc (DVD) disc drive 806 coupled to the processor 801. The server 800 may also include network access ports 803 coupled to the multicore processor assemblies 801 for establishing network interface connections with a network 805, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

Implementation examples are described in the following paragraphs. While some of the following implementation examples are described in terms of example methods, further example implementations may include: the example methods discussed in the following paragraphs implemented by a computing device comprising a processing device configured with processing device-executable instructions to perform operations of the example methods: the example methods discussed in the following paragraphs implemented by a computing device including means for performing functions of the example methods; and the example methods discussed in the following paragraphs implemented as a non-transitory processor-readable storage medium having stored thereon processor-executable instructions configured to cause a processor of a computing device to perform the operations of the example methods.
Example 1. Example 1. A method of identifying core threads of a program executing by a processor, including: hooking an event by a kernel interface: calculating a total time cost for executing a thread of the program based on hooking the event by the kernel interface: returning the total time cost for executing the thread and a thread identifier of the thread to a core thread identifier program by a kernel of the processor; and determining a core thread of the program based on the total time cost for executing the thread and the thread identifier of the thread by the core thread identifier program.
Example 2. The method of example 1, further including calculating a duration of at least one task of the thread based on hooking the event.
Example 3. The method of example 2, in which the event includes a switch in of a running processor execution state and out of the running processor execution state for the processor.
Example 4. The method of any of examples 1-3, further including: calculating an aggregate duration for executing at least one task of the thread based on hooking the event; and determining whether the aggregate duration for executing the at least one task of the thread exceeds an aggregation threshold, in which calculating the total time cost for executing the thread of the program based on hooking the event includes calculating the total time cost for executing the thread of the program in response to determining that the aggregate duration for executing the at least one task of the thread exceeds the aggregation threshold.
Example 5. The method of any of examples 1-4, further including calculating a representation of the total time cost for executing the thread.
Example 6. The method of example 5, further including: comparing the representation of the total time cost for executing the thread to at least one other representation of a total time cost for executing a thread, in which determining the core thread of the program includes comparing a result of the comparison of the representation of the total time cost for executing the thread to at least one other representation of a total time cost for executing a thread to at least one range of values in which the result of the comparison indicates that a corresponding thread to the representation of the total time cost for executing the thread is a core thread.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations: these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method of identifying core threads of a program executing by a processor, comprising:
hooking an event by a kernel interface;
calculating a total time cost for executing a thread of the program based on hooking the event by the kernel interface;
returning the total time cost for executing the thread and a thread identifier of the thread to a core thread identifier program by a kernel of the processor; and
determining a core thread of the program based on the total time cost for executing the thread and the thread identifier of the thread by the core thread identifier program.

2. The method of claim 1, further comprising calculating a duration of at least one task of the thread based on hooking the event.

3. The method of claim 2, wherein the event includes a switch in of a running processor execution state and out of the running processor execution state for the processor.

4. The method of claim 1, further comprising:
calculating an aggregate duration for executing at least one task of the thread based on hooking the event; and
determining whether the aggregate duration for executing the at least one task of the thread exceeds an aggregation threshold,
wherein calculating the total time cost for executing the thread of the program based on hooking the event comprises calculating the total time cost for executing the thread of the program in response to determining that the aggregate duration for executing the at least one task of the thread exceeds the aggregation threshold.

5. The method of claim 1, further comprising calculating a representation of the total time cost for executing the thread.

6. The method of claim 5, further comprising:
comparing the representation of the total time cost for executing the thread to at least one other representation of a total time cost for executing a thread,
wherein determining the core thread of the program comprises comparing a result of the comparison of the representation of the total time cost for executing the thread to at least one other representation of a total time cost for executing a thread to at least one range of values in which the result of the comparison indicates that a corresponding thread to the representation of the total time cost for executing the thread is a core thread.

7. A computing device, comprising:
a memory; and
a processor couple do the memory and configured to:
hook an event by a kernel interface in a program executing in the processor;
calculate a total time cost for executing a thread of the program based on hooking the event by the kernel interface;
return the total time cost for executing the thread and a thread identifier of the thread to a core thread identifier program by a kernel of the processor; and
determine a core thread of the program based on the total time cost for executing the thread and the thread identifier of the thread by the core thread identifier program.

8. computing device method of claim 7, wherein the processor is further configured to calculate a duration of at least one task of the thread based on hooking the event.

9. The computing device of claim 8, wherein the event includes a switch in of a running processor execution state and out of the running processor execution state for the processor.

10. The computing device of claim 7, wherein the processor is further configured to:
calculate an aggregate duration for executing at least one task of the thread based on hooking the event; and
determine whether the aggregate duration for executing the at least one task of the thread exceeds an aggregation threshold,
wherein the processor is further configured to calculate the total time cost for executing the thread of the program in response to determining that the aggregate duration for executing the at least one task of the thread exceeds the aggregation threshold.

11. The computing device of claim 7, wherein the processor is further configured to calculate a representation of the total time cost for executing the thread.

12. The computing device of claim 11, wherein the processor is further configured to:
compare the representation of the total time cost for executing the thread to at least one other representation of a total time cost for executing a thread,
wherein the processor is further configured to determine the core thread of the program by comparing a result of the comparison of the representation of the total time cost for executing the thread to at least one other representation of a total time cost for executing a thread to at least one range of values in which the result of the comparison indicates that a corresponding thread to the representation of the total time cost for executing the thread is a core thread.

13. A computing device, comprising:
means for hooking an event by a kernel interface of a program executing in the computing device;
means for calculating a total time cost for executing a thread of the program based on hooking the event by the kernel interface;
means for returning the total time cost for executing the thread and a thread identifier of the thread to a core thread identifier program by a kernel of the processor; and
means for determining a core thread of the program based on the total time cost for executing the thread and the thread identifier of the thread by the core thread identifier program.

14. The computing device of claim 13, further comprising means for calculating a duration of at least one task of the thread based on hooking the event.

15. The computing device of claim 14, wherein the event includes a switch in of a running processor execution state and out of the running processor execution state for the processor.

16. The computing device of claim 13, further comprising:
means for calculating an aggregate duration for executing at least one task of the thread based on hooking the event; and
means for determining whether the aggregate duration for executing the at least one task of the thread exceeds an aggregation threshold,
wherein means for calculating the total time cost for executing the thread of the program based on hooking the event comprises means for calculating the total time cost for executing the thread of the program in response to determining that the aggregate duration for executing the at least one task of the thread exceeds the aggregation threshold.

17. The computing device of claim 13, further comprising means for calculating a representation of the total time cost for executing the thread.

18. The computing device of claim 17, further comprising:
means for comparing the representation of the total time cost for executing the thread to at least one other representation of a total time cost for executing a thread,
wherein means for determining the core thread of the program comprises means for comparing a result of the comparison of the representation of the total time cost for executing the thread to at least one other representation of a total time cost for executing a thread to at least one range of values in which the result of the comparison indicates that a corresponding thread to the representation of the total time cost for executing the thread is a core thread.

19. A non-transitory processor-readable medium having stored thereon processor-executable instructions configured to cause a processor to perform operations for identifying core threads of a program executing by the processor comprising:
hooking an event by a kernel interface;
calculating a total time cost for executing a thread of the program based on hooking the event by the kernel interface;
returning the total time cost for executing the thread and a thread identifier of the thread to a core thread identifier program by a kernel of the processor; and
determining a core thread of the program based on the total time cost for executing the thread and the thread identifier of the thread by the core thread identifier program.

20. The non-transitory processor-readable medium of claim 19, wherein the stored processor-executable instructions are configured to cause the processor to perform operations further comprising calculating a duration of at least one task of the thread based on hooking the event.

21. The non-transitory processor-readable medium of claim 20, wherein the event includes a switch in of a running processor execution state and out of the running processor execution state for the processor.

22. The non-transitory processor-readable medium of claim 19, wherein the stored processor-executable instructions are configured to cause the processor to perform operations further comprising:
calculating an aggregate duration for executing at least one task of the thread based on hooking the event; and
determining whether the aggregate duration for executing the at least one task of the thread exceeds an aggregation threshold,
wherein the stored processor-executable instructions are configured such that calculating the total time cost for executing the thread of the program based on hooking the event comprises calculating the total time cost for executing the thread of the program in response to determining that the aggregate duration for executing the at least one task of the thread exceeds the aggregation threshold.

23. The non-transitory processor-readable medium of claim 19, wherein the stored processor-executable instructions are configured to cause the processor to perform operations further comprising calculating a representation of the total time cost for executing the thread.

24. The non-transitory processor-readable medium of claim 23, wherein the stored processor-executable instructions are configured to cause the processor to perform operations further comprising:
comparing the representation of the total time cost for executing the thread to at least one other representation of a total time cost for executing a thread,
wherein the stored processor-executable instructions are configured such that determining the core thread of the program comprises comparing a result of the comparison of the representation of the total time cost for executing the thread to at least one other representation of a total time cost for executing a thread to at least one range of values in which the result of the comparison indicates that a corresponding thread to the representation of the total time cost for executing the thread is a core thread.
